(19) United States
(12) Patent Application Publication
(10) Pub. No.: US 2003/0107377 A1
(43) Pub. Date: Jun. 12, 2003

(54) Metal detector

(76) Inventor: Mustafa Uzman, Bocholt (DE)

Correspondence Address: Norris, McLaughlin & Marcus P.A., 30th Floor, 220 East 42nd Street, New York, NY, 10017, US

(21) Appl. No.: 10/303,041

(22) Filed: Nov. 22, 2002

(30) Foreign Application Priority Data
Nov. 27, 2001 (DE) 101 57 770.2-52

(51) Int. Cl. G01V 3/08; G01V 3/10

(52) U.S. Cl. 324/327

(57) ABSTRACT

The invention relates to a metal detector with at least one driver circuit 2, at least one transmitter winding 4 having two external terminals 4a, b, and at least one receiver winding 5 having two external terminals 5a, b. The efficiency is increased in comparison to conventional metal detectors by providing at least one tap subdividing the transmitter winding 4, whereby a transformed electrical AC voltage is provided at the external terminals 4a, b of the transmitter winding 4 by the driver circuit via the tap 4c.

### BACKGROUND OF THE INVENTION

This invention relates to a metal detector with at least one transmitter winding with two external terminals and at least one receiver winding also with two external terminals and at least one driver circuit. The invention also relates to a method for operating a metal detector.

A conventional metal detector includes a probe head with a transmitter coil and a receiver coil. The transmitter coil is composed of windings capable of generating a magnetic field. The transmitter and receiver coils are frequently also referred to as transmitter and receiver windings. An electrical AC voltage is applied to the transmitter coil by way of a driver circuit, preferably an oscillator. The transmitter windings produce a magnetic AC field in the vicinity of the transmitter coil through electromagnetic induction. This magnetic field can be received by a receiver coil formed of a receiver winding.

The receiver coil is connected to a detector circuit via an amplifier. The detector circuit can detect variations in the magnetic field of the transmitter coil produced by metallic objects located in the vicinity of the coils.

Both the transmitter coil and the receiver coil are frequently connected to driver circuits having capacitors, forming parallel or series oscillating circuits. These oscillating circuits are preferably operated at resonance so as to maximize the magnetic field strength.

German patent DE 198 03 957 C1 describes a metal detector and a method for detecting a metallic object. To provide a metal detector with a higher sensitivity that can be operated easily by a non-expert, it is proposed to provide an automatic control for the oscillating circuit. The oscillating circuit has an adjustable resistor for varying the feedback between the oscillating circuit and the search coil in such a way that the oscillating circuit is in a state short of the onset of oscillations. The search coil, which at the same time is the oscillator coil, has a tap. The strength of the coupling between the search coil and the oscillator coil can be adjusted via a potentiometer.

The German laid-open application DE 199 63 773 also describes a metal detector and a method for operating a metal detector. In this method, an oscillator is provided which causes an oscillating circuit to radiate electromagnetic AC fields. The AC fields and hence the oscillating characteristics of the oscillator are influenced by the presence of metal. The operating point of the oscillator can be changed by controlling the phase of the feedback voltage from the oscillator. For increasing the operating range and having the option to adapt to different environmental situations, it is proposed to suppress different phase relationships of the feedback voltage, which makes it possible to distinguish between different effects produced by the surroundings.

The German laid-open application DE 198 50 748 describes a sensor which responds to the proximity of metals. An axially oriented coil system is provided which has at least three electromagnetically or magnetically coupled coils. The signal present at the detector coil and at the generator coil is supplied to a mixer. In this way, the distance between a metallic object and the sensor-coil system can be unambiguously determined with an inductively operating proximity switch that also operates in a higher frequency range of 500 kHz.

United Kingdom patent publication GB 1 436 900 relates to a device for detecting a movement of metallic or non-metallic objects through a metal detection station. To reliably detect the objects without having the device react to metallic objects located outside the metal detection station, it is proposed to provide one transmitter coil with one winding and two receiver coils, with each receiver coil having one winding. The two receiver coils are located on opposite sides of the transmitter coil. The transmitter coil and the receiver coils are powered by a driver circuits having tuned frequencies.

German utility model DE 200 11 966 U1 is directed to a sensor that measures a capacitance change of a capacitor and transforms the capacitance change into a voltage signal. To provide such a sensor capable of capacitively locating two objects that move relative to each other, it is proposed to connect the primary and secondary coils with the electrodes of the capacitors. An additional electrode of the capacitors is proposed which forms an electrical stray field to the first capacitor electrodes, thereby forming respective stray field capacitors. The change of the stray field capacitance by an approaching object can be detected if a difference voltage is present at a tertiary coil.

Finally, the German patent DE 196 51 923 C2 describes a sensor for detecting magnetic AC fields. A pick-up coil with a high permeability is here surrounded by several coils connected in series. To optimize the detection of low-frequency magnetic AC fields in water, it is proposed to form the pick-up coil of flat strips, which are composed of amorphous or micro-crystalline magnetizable material. An electrically insulating strip is inserted between these strips. Employing the insulating strips eliminates eddy currents which considerably interfered with the magnetic field to be measured.

In conventional circuits, the available electrical energy which is normally supplied by a conventional battery, disadvantageously limits the magnetic energy of the magnetic field. However, since the magnetic field strength is essential for a successful metal detection, many attempts have been made to increase the magnetic field strength. For example, it has been proposed to accumulate electric charge in a capacitor and supply this charge in a concentrated fashion so as to increase the voltage supplied to the transmitter coil. However, such circuits have the disadvantages of significantly increasing the complexity of circuits and thereby also the manufacturing cost of metal detectors.

As a result of the aforedescribed disadvantages, it is an object of the present invention to increase the efficiency of conventional metal detectors in a simple matter. Further objects and advantages of the invention will become apparent from a consideration of the ensuing description and drawings.

### BRIEF DESCRIPTION OF THE DRAWINGS

In the drawings,

FIGS. 1 a-c show conventional coil arrangements of probe heads as known from the prior art, and

FIG. 2 shows a circuit diagram for a metal detector according to the present invention.

### SUMMARY OF THE INVENTION

In accordance with the present invention a metal detector is provided which comprises

at least one transmitter winding (4) which has at least two external terminals (4a, b),

at least one receiver winding (5) which has at least two external terminals (5a, b),

at least one driver circuit (2), and

wherein the external terminals (4a, b) of the transmitter winding (4) can be supplied with a transformed electrical AC voltage by the driver circuit (2) via a tap (4c).

### DETAILED DESCRIPTION OF THE INVENTION

In the metal detector according to the present invention at least one tap is provided that subdivides the transmitter winding, whereby the external terminals of the transmitter winding can be supplied with a transformed electrical AC voltage by the driver circuit via a tap.

It has been observed in the course of this invention, that the transmitter winding itself can be used as a transformer by providing a tap along the transmitter winding. An electrical AC voltage is applied by the driver circuit to a first section of the transmitter coil between an outer terminal and the tap that subdivides the transmitter winding. A magnetic field is induced by the electrical AC voltage in the first section of the transmitter winding, which propagates in the direction of the entire transmitter winding. This in turn produces an induction current in the remaining transmitter winding. This induced current is greater than that current applied via the driver circuit, thereby amplifying the external magnetic field.

According to a preferred embodiment of the present invention the tap subdivides the transmitter winding non-symmetrically. Preferably, the tap is arranged at approximately one sixth of the length of the entire winding. The voltage induced between the outer terminals and the tap in the remaining transmitter winding is therefore upconverted sixfold. Accordingly, the magnetic field increases sevenfold.

In order to utilize the energy applied by the driver circuit as efficiently as possible, it is proposed in one embodiment of the invention that the driver circuit in conjunction with an outer terminal of the transmitter winding and the tap of the transmitter winding forms a first oscillating circuit. The supplied energy can be optimally converted into a magnetic field by operating the first oscillating circuit at resonance.

According to another preferred embodiment of the present invention an additional oscillating circuit is formed between the outer terminals of the transmitter winding. The magnetic field energy can be increased once more by preferably operating the additional oscillating circuit at the same resonance frequency as the first oscillating circuit.

According to another preferred embodiment of the present invention the driver circuit can include an oscillator which can generate an electromagnetic oscillation in the driver circuit. The oscillator can be connected, for example, via a transistor emitter path with the oscillating circuit of the transmitter coil. The oscillator excites the oscillating circuits, for example at their resonance frequency. Preferably, the oscillator is coupled via a feedback loop with the oscillating circuits, allowing the oscillator to adapt to the resonance frequency of the oscillating circuits. In this case, the parallel oscillating circuit is always excited at its characteristic resonance frequency.

By substantially magnetically decoupling the transmitter winding from the receiver winding, a voltage of approximately 0 is induced at the receiver winding if no metallic object is located in the magnetic field. With magnetic decoupling, the magnetic field produced in the transmitter winding does not induce a voltage in the receiver winding. The magnetic field of the transmitter coil changes only if a metallic object is located in the vicinity of the transmitter coil. In this case, the magnetic decoupling between the receiver coil and the transmitter coil is disturbed and a portion of the magnetic field of the transmitter coil induces a voltage in the receiver coil. This induced voltage can be measured via an amplifier.

According to another preferred embodiment of the present invention the change in the magnetic field of the transmitter coil can be measured by forming a third oscillating circuit with the receiver winding. The third oscillating circuit is preferably tuned to the resonance frequency of the first and second oscillating circuit.

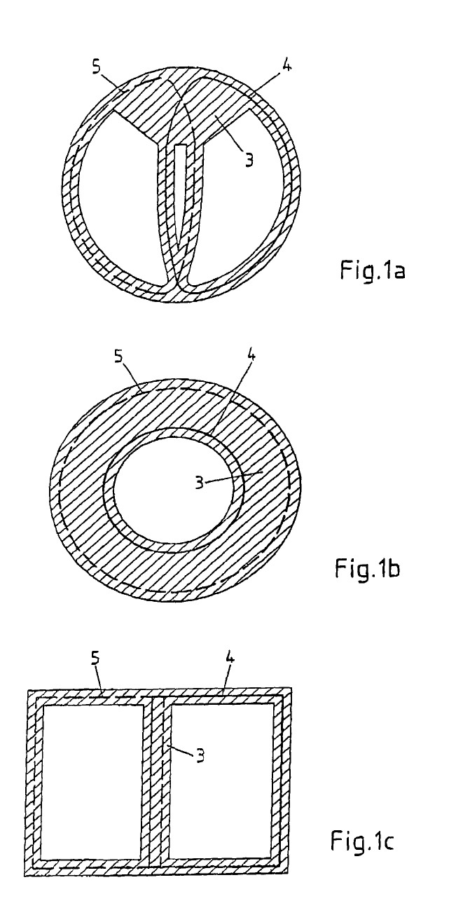

The transmitter and receiver windings can have an arbitrary shape; more particularly, the transmitter and receiver windings can have the shapes illustrated in FIGS. 1a, 1b and 1c.

A further aspect of the invention relates to a method for operating a metal detector, wherein the transmitter winding is powered by an electrical AC voltage applied by a driver circuit between an outer terminal of the transmitter winding and a tap located non-symmetrically on the transmitter winding, whereby the electrical AC voltage is transformed over the entire transmitter winding.

For the purpose of illustration the present invention will now be described with reference to the attached drawings depicting specific embodiments of the present invention.

FIG. 1a shows a conventional D-shaped probe head as known from the prior art with a coil arrangement composed of a transmitter winding 4 and a receiver winding 5. The transmitter winding 4 and the receiver winding 5 are arranged on a metallic support 3. The transmitter winding 4 is arranged relative to the receiver winding 5 so that the magnetic field generated by the transmitter winding 4 induces only a very small voltage in the receiver winding 5. Only external effects, for example the presence of a metallic object, that change the magnetic field generated by the transmitter winding 4, induce a greater voltage in the receiver winding 5.

A conventional probe head as known from the prior art constructed according to FIG. 1b allows the transmitter winding 4 to be efficiently decoupled from the receiver winding 5. The magnetic flux of the transmitter winding 4 is guided primarily inside the transmitter winding 4 within the metallic support 3. As a result, the sum of the magnetic fluxes enclosed by the receiver winding 5 is essentially equal to 0.

The same applies to a conventional probe head as known from the prior art constructed according to FIG. 1c. The intersecting transmitter winding 4 and receiver winding 5 in the center yoke of the metallic support 3 also cause the sum of the magnetic fluxes enclosed by the receiver winding 5 to be approximately 0.

The coil arrangements depicted in FIGS. 1a-c enable a reliable detection of metallic objects in the vicinity of the coils. The induced voltage of the receiver coil 5, which is typically approximately 0, can be strongly amplified under normal operating conditions. A metallic object in the vicinity of the transmitter coil 4 induces a small voltage in the receiver coil 5, which can then be amplified and readily detected.

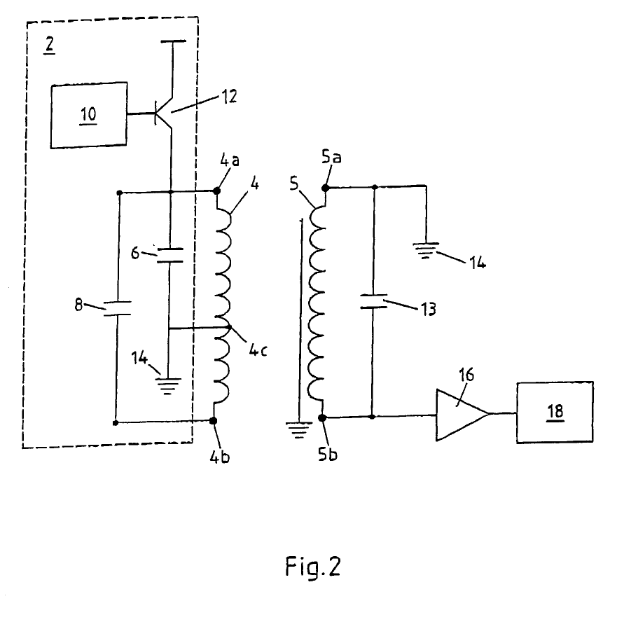

FIG. 2 depicts a circuit diagram for a metal detector according to the present invention. Shown is a driver circuit 2 which supplies a transmitter winding 4 having outer terminals 4a, 4b and a tap 4c. A receiver winding 5 with outer terminals 5a and 5b is also shown. The driver circuit 2 is formed of the capacitors 6 and 8 and is powered the oscillator 10 which is coupled to the oscillating circuits via the transistor 12. The capacitor 6 in conjunction with the terminal 4a and the tap 4c of the transmitter winding 4 forms a first oscillating circuit. The capacitor 8 in conjunction with the transmitter winding 4 forms a second oscillating circuit. The two oscillating circuits are tuned to each other and have the same resonance frequency.

The capacitor 13 together with the receiver winding 5 forms a third resonant oscillating circuit with a resonance frequency that is tuned to the resonance frequency of the first two oscillating circuits. The voltage induced in the receiver winding 5 is amplified by an amplifier 16 and supplied to a detector 18.

The oscillator 10 is coupled to ground 14 via the emitter of the transistor 12 and the capacitor 6. Preferably, the oscillator 10 is coupled to the first two oscillating circuits so as to automatically tune to their intrinsic resonance frequency.

The electrical AC voltage applied via the transistor 12 is received by the first parallel oscillating circuit which oscillates at its intrinsic resonance frequency, thereby increasing the induced current between the terminal 4a and the tap 4c of the transmitter winding 4. Since the tap 4c subdivides the transmitter winding 4 non-symmetrically, the applied voltage is transformed. The voltage between the outer terminals 4a and 4b corresponds to the winding ratio between the transmitter winding 4 and the windings between the terminal 4a and the tap 4c. By upconverting the induced voltage, the strength of the external magnetic field of the transmitter winding is increased. This magnetic field radiates over a large area and accordingly enables the detection of metallic objects even at a large depth below the ground level.

The current flowing through the transistor 12 is higher than in conventional circuits, since the current flows to ground potential via a smaller impedance, namely only the impedance between the terminal 4c and the tap 4c. The causes an increase in the voltage of the first winding section between the terminal 4a and the tap 4c, which is in addition upconverted.

The receiver is preferably a heterodyne receiver having the same clock frequency as the oscillator of the transmitter. Only the sidebands of the transmitter are detected, and a phase relation between the transmitter frequency and the received echo is measured. If an object is located in the vicinity of the coils, a phase shift is measured between the echo and the transmitter frequency which can be displayed on the detector.

Although the description above may contain some specificities, these should not be construed as limiting the scope of the invention but as merely providing illustrations of some of the presently preferred embodiments of this invention. Thus, the scope of the invention should be determined by the appended claims and their legal equivalents, rather than by the examples given.

What is claimed is:

1. A metal detector comprising
at least one transmitter winding (4) which has at least two external terminals (4a, b),
at least one receiver winding (5) which has at least two external terminals (5a, b),
at least one driver circuit (2),
wherein the external terminals (4a, b) of the transmitter winding (4) can be supplied with a transformed electrical AC voltage by the driver circuit (2) via a tap (4c).

2. The metal detector of claim 1, wherein the tap (4c) subdivides the transmitter winding (4) non-symmetrically.

3. The metal detector of claim 1, wherein the driver circuit (2) in conjunction with an outer terminal (4a) of the transmitter winding (4) and the tap (4c) of the transmitter winding (4) forms a first oscillating circuit (4a, 4c, b).

4. The metal detector of claim 1, wherein a second oscillating circuit is formed between the outer terminals (4a, b) of the transmitter winding (4).

5. The metal detector of claim 4, wherein the first and second oscillating circuit have an essentially identical resonance frequency.

6. The metal detector of claim 1, wherein the driver circuit (2) comprises an oscillator (10) capable of generating an electromagnetic oscillation in the driver circuit (2).

7. The metal detector of claim 1, wherein the transmitter winding (4) and the receiver winding (5) are substantially decoupled magnetically.

8. The metal detector of claim 1, wherein a third oscillating circuit is formed with the receiver winding (5).

9. A method for operating a metal detector, wherein a transmitter winding is supplied with an electrical AC voltage that is applied by a driver circuit between an outer terminal of the transmitter winding and a tap located non-symmetrically on the transmitter winding, whereby the electrical AC voltage is transformed over the entire transmitter winding.
